(19) United States
(12) Patent Application Publication
(10) Pub. No.: US 2023/0114374 A1
(43) Pub. Date: Apr. 13, 2023

(54) STORAGE MEDIUM, MACHINE LEARNING APPARATUS, AND MACHINE LEARNING METHOD

(71) Applicant: Fujitsu Limited, Kawasaki-shi (JP)

(72) Inventor: Moyuru YAMADA, Yokohama (JP)

(73) Assignee: Fujitsu Limited, Kawasaki-shi (JP)

(21) Appl. No.: 17/959,524

(22) Filed: Oct. 4, 2022

(30) Foreign Application Priority Data
Oct. 8, 2021 (JP) 2021-166224

(51) Int. Cl. G06V 10/82; G06V 10/74; G06N 3/04

(52) U.S. Cl. CPC G06V 10/82; G06V 10/761; G06N 3/0454

(57) ABSTRACT

A storage medium storing a machine learning program that causes a computer to execute a process that includes generating a feature of a training image by inputting the training image to a first model; generating text corresponding to the training image by inputting first training text to the first model; generating a feature of second training text, for which a correct answer as to whether the second training text corresponds to the training image is known, by inputting the second training text to a second model; and changing a parameter of the first model and a parameter of the second model so that a first error between the first training text and the generated text corresponding to the training image and a second error between the correct answer and a degree of similarity between the feature of the training image and the feature of the second training text decrease.

### CROSS-REFERENCE TO RELATED APPLICATION

This application is based upon and claims the benefit of priority of the prior Japanese Patent Application No. 2021-166224, filed on Oct. 8, 2021, the entire contents of which are incorporated herein by reference.

### FIELD

The embodiments discussed herein are related to a storage medium, a machine learning apparatus, and a machine learning method.

### BACKGROUND

There exists a technique for searching for an image or text similar to a search query by, for search-target images or text, calculating the degree of similarity with text or an image that is to serve as the search query and sequencing and outputting the search targets based on the calculated degree of similarity.

Relating to such a search technique, for example, there has been proposed a technique in which, for a correct pair of an image and text, an incorrect pair is generated by replacing one of the image and the text with a random sample that does not match the other of the image and the text at a certain probability. According to this technique, a single pair is input to a neural network such as a transformer to generate an image vector representing the feature of the image and a text vector representing the feature of the text. According to this technique, machine learning of a linear network (LN) that calculates the degree of similarity between the image and the text is executed based on the degree of similarity between the image vector and the text vector and a correct answer as to whether the pair of the image and the text is a correct pair.

Also, a technique has been proposed in which, for a pair of an image and text, an image and text are each independently input to a neural network to generate an image vector and a text vector, and machine learning is executed based on the degree of similarity between both.

Also, a technique has been proposed in which machine learning of association between an image and correct answer text corresponding to the image is executed so as to generate a machine learning model including, for example, a neural network that may generate, from a given image, text corresponding to the image.

U.S. Patent Application Publication No. 2017/0061250 is disclosed as related art.

Jiasen Lu, Dhruv Batra, Devi Parikh, Stefan Lee, “ViLBERT: Pretraining Task-Agnostic Visiolinguistic Representations for Vision-and-Language Tasks”, arXiv: 1908.02265v1 [cs.CV] 6 Aug. 2019, Qingqing Cao, Harsh Trivedi, Aruna Balasubramanian, Niranjan Balasubramanian, “DeFormer: Decomposing Pre-trained Transformers for Faster Question Answering”, arXiv: 2005.00697v1 [cs.CL] 2 May 2020, and Alec Radford, Karthik Narasimhan, Tim Salimans, Ilya Sutskever, “Improving Language Understanding by Generative Pre-Training”, 2018 are also disclosed as related art.

### SUMMARY

According to an aspect of the embodiments, a non-transitory computer-readable storage medium storing a machine learning program that causes at least one computer to execute a process, the process includes obtaining a first model to which an image is input and a text corresponding to the image is input word by word, the first model generating a feature of the image and predicting words of the text that have not been input to the first model; generating a feature of a training image by inputting the training image to the first model; predicting words of a text corresponding to the training image by inputting first training text corresponding to the training image to the first model word by word; generating a feature of second training text, for which a correct answer as to whether the second training text corresponds to the training image is known, by inputting the second training text to a second model that generates a feature of text input to the second model; and changing a parameter of the first model and a parameter of the second model so that a first error and a second error decrease, the first error being between the first training text and the generated text corresponding to the training image, the second error being between the correct answer and a degree of similarity between the feature of the training image and the feature of the second training text.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining comparative technique 1;

FIG. 2 is a diagram for explaining comparative technique 2;

FIG. 3 is a diagram for explaining comparative technique 3;

FIG. 4 is a functional block diagram of a machine learning apparatus according to first to third embodiments;

FIG. 5 is a diagram for explaining processing at a machine learning stage according to the first embodiment;

FIG. 6 is a diagram for explaining the reference relationships between an image and text at the time of generating an image vector and at the time of generating a corresponding text according to the first embodiment;

FIG. 7 is a functional block diagram of a search apparatus according to the first and third embodiments;

FIG. 8 is a diagram for explaining processing at a preliminary preparation stage and search stage according to the first embodiment;

FIG. 9 is a diagram illustrating an example of a candidate image vector database (DB);

FIG. 10 is a block diagram schematically illustrating the configuration of a computer that functions as the machine learning apparatus;

FIG. 11 is a block diagram schematically illustrating the configuration of a computer that functions as a search apparatus;

FIG. 12 is a flowchart illustrating an example of a machine learning process according to the first and second embodiments;

FIG. 13 is a flowchart illustrating an example of a preliminary preparation process according to the first and third embodiments;

FIG. 14 is a flowchart illustrating an example of a search process according to the first to third embodiments;

FIG. 15 is a diagram for explaining a case where the corresponding text is generated after the image vector has been generated;

FIG. 16 is a diagram for explaining the reference relationships between the image and the text at the time of generating the image vector and at the time of generating the corresponding text according to the second embodiment;

FIG. 17 is a functional block diagram of a search apparatus according to the second embodiment;

FIG. 18 is a diagram for explaining processing at a preliminary preparation stage according to the second embodiment;

FIG. 19 is a flowchart illustrating an example of the preliminary preparation process according to the second embodiment;

FIG. 20 is a diagram for explaining processing at a machine learning stage according to the third embodiment; and

FIG. 21 is a flowchart illustrating an example of a machine learning process according to the third embodiment.

### DESCRIPTION OF EMBODIMENTS

According to the technique in which the pair of the image and the text is input to the neural network so as to execute the machine learning of the function that calculates the degree of similarity between the image and the text, the text and the image are desired to refer to each other in the neural network for calculating the degree of similarity between the image and the text. For example, the vector of the search query changes in accordance with the search target, and the search target is not necessarily vectorized in advance. Accordingly, it is desired to input all combinations of search queries and search targets to the neural network to calculate the degree of similarity between the text that is the search queries and the images that are the search targets. Thus, when the number of search targets significantly increases, the time to output a result of sequencing of the search targets increases.

According to the technique in which the image vector and the text vector are generated independently of each other, a processing result of an independently processed portion may be stored and reused. Accordingly, the image vector of each image serving as the search target may be calculated in advance. In this technique, at the time of searching, it is sufficient that only the text vector of the text that is the search query be generated. With this, the degree of similarity with each of the image vectors having been calculated in advance may be calculated, and accordingly, the degree of similarity may be calculated at high-speed. However, the vectorization processes for the image and the text are completely separated from each other, it is difficult to progress training of the correspondence between the search target and the search query, and accuracy of calculation of the degree of similarity degrades.

According to the technique in which the machine learning model that may generate the text corresponding to the given image is generated, since the machine learning model is not designed for calculating the degree of similarity between the image and the text, vectorization of the text and the image is not directly performed. Accordingly, this technique is not necessarily applicable to the technique for searching for the image similar to the text that is the search query from the images that are the search targets.

In one aspect, the disclosed technique is aimed at, in a case where an image similar to text that is a search query is searched from images that are search targets, both suppressing the degradation in accuracy of calculation of the degree of similarity and increasing in speed of processing at the time of search.

Hereinafter, an example of embodiments according to the disclosed technique will be described with reference to the drawings.

First, before the details of each embodiment are described, problems in three techniques for comparison (hereinafter, referred to as “comparative technique 1”, “comparative technique 2”, and “comparative technique 3”) in a case where an image similar to text that is a search query is searched from an image that is a search target will be described.

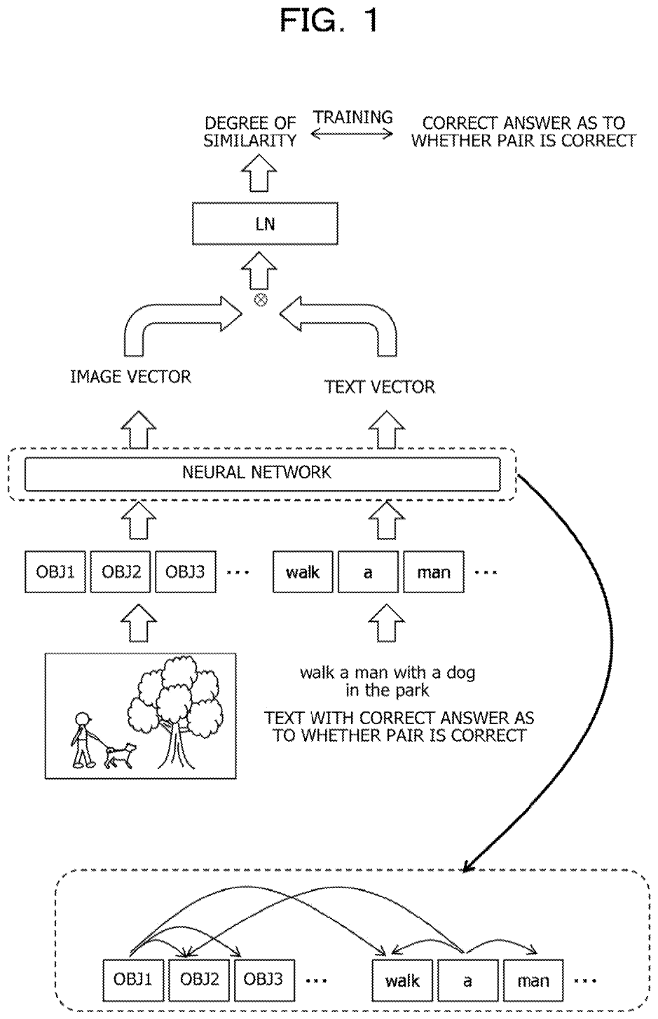

Comparative technique 1 corresponds to the above-described technique in which a pair of an image and text is input to a neural network and machine learning for a function for calculating the degree of similarity between the image and text is executed. For example, as illustrated in FIG. 1, in comparative technique 1, elements extracted from the image and elements extracted from the text are input to the neural network. Here, the text is text to which a correct answer as to whether correspondence with the image input to the neural network is a correct pair is given (hereinafter, referred to as “text with a correct answer”). In the example illustrated in FIG. 1, the elements extracted from the image are vectors representing respective objects included in the image (hereinafter, referred to as “object vectors”). The elements extracted from the text are vectors representing respective words included in the text (hereinafter, referred to as “word vectors”). In FIG. 1, the object vectors are represented by blocks such as “OBJ1”, “OBJ2”, “OBJ3”, . . . , and the word vectors are represented by blocks such as “walk”, “a”, “man”, . . . . These representations are similarly used in the drawings to be referred to below.

As indicated by a dotted box in FIG. 1, in the neural network, an image vector representing a feature of the image and a text vector representing a feature of the text are generated while mutually referring to the object vectors and the word vectors. The degree of similarity calculated by a linear network (LN) that calculates the degree of similarity between the image vector and the text vector is compared with the correct answer given to the text to determine whether the pair is a correct pair, and machine learning of the neural network and the LN is executed such that the degree of similarity and the correct answer match each other.

As described above, in comparative technique 1, since it is desired that the image vector and the text vector be generated while mutual reference is performed between the image and text, an image vector is not able to be generated in advance for each of the images which are search targets. For example, at the time of searching, it is desired that an image vector of each of the search-target images be generated. For example, in a case where the number of search-target images is 100, it is desired that both the image vector and the text vector be generated 100 times. Thus, the speed of the processing at the time of the search is not able to be increased in comparative technique 1.

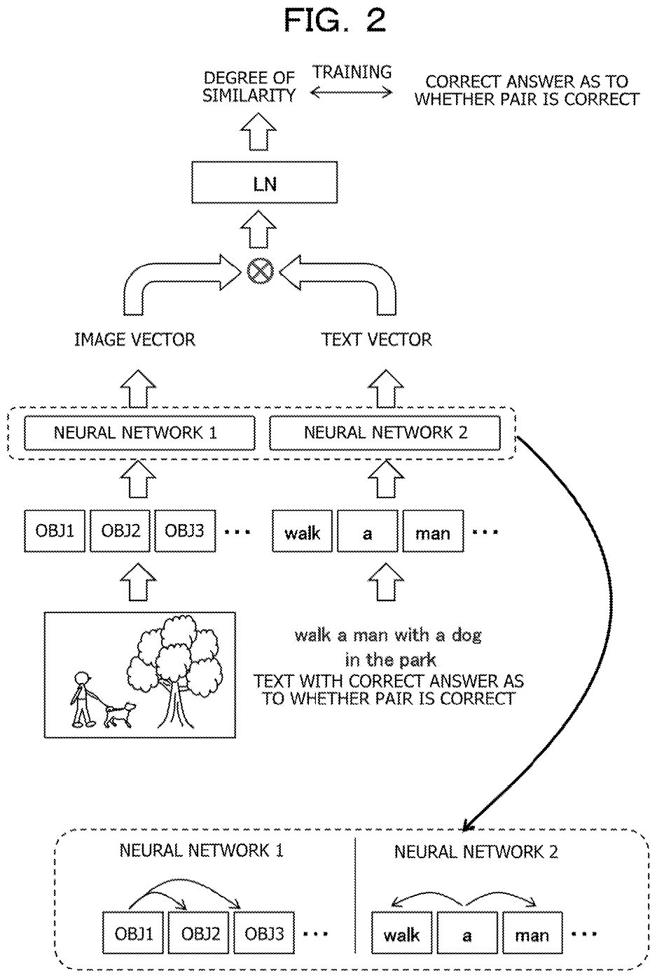

Comparative technique 2 corresponds to the above-described technique in which the image vector and the text vector are independently generated. For example, as illustrated in FIG. 2, in comparative technique 2, the object vectors extracted from the image are input to neural network 1 to generate the image vector, and the word vectors extracted from the text are input to neural network 2 to generate the text vector. In so doing, as indicated by a dotted box in FIG. 2, the image vector is generated by referring only to the object vectors in neural network 1, and the text vector is generated by referring only to the word vectors in neural network 2. For example, the image vector and the text vector are generated without mutual reference between the image and the text. The processing at the later stage is similar to that of comparative technique 1.

As described above, the image vector and the text vector are generated independently of each other in comparative technique 2. Thus, the image vector of each image which becomes the search target may be generated in advance, and accordingly, the speed of processing at the time of search may be increased. In contrast, compared to the case where the search target and the search query refer to each other as in comparative technique 1, it is difficult to progress training of the correspondence between the search target and the search query, and accuracy of calculation of the degree of similarity degrades.

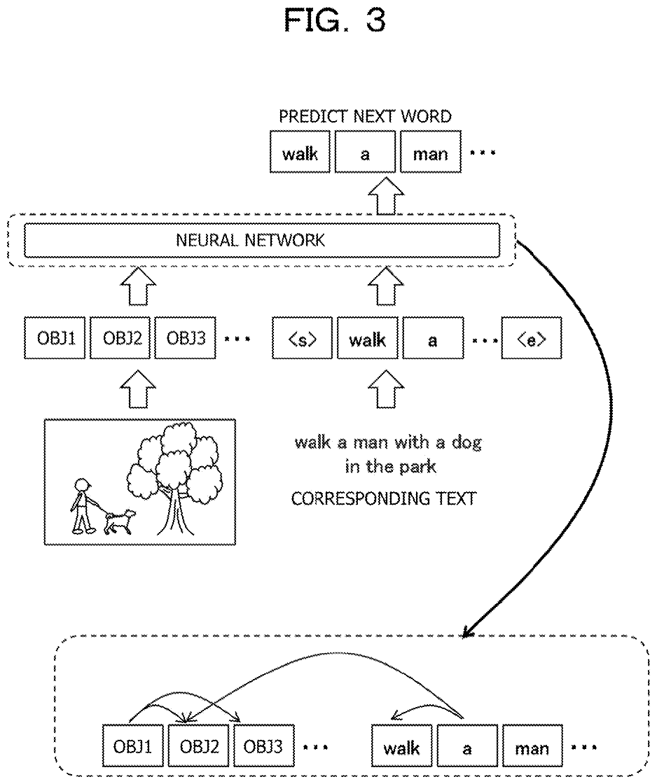

Comparative technique 3 corresponds to the above-described technique for generating a machine learning model that may generate text corresponding to a given image. For example, as illustrated in FIG. 3, in comparative technique 3, the object vectors extracted from the image and the word vectors of the text corresponding to the image (hereinafter, referred to as “corresponding text”) are input to the neural network. In FIG. 3, an “<s>” block is a vector indicating the start of the text, and an “<e>” block is a vector indicating the end of the text. These representations are similarly used in the drawings to be referred to below.

The neural network integrates features extracted from an object vector group and features extracted from a word vector group to predict the next word from an image and <s>. The neural network adds the predicted word to the image and <s> and repeatedly predicts the next word to create text corresponding to the image. In so doing, as indicated by a dotted box illustrated in FIG. 3, reference between the object vectors, reference from the word vectors to the object vectors, and reference from word vectors to preceding word vectors are performed in the neural network. In comparative technique 3, since the text is generated by predicting the next word, reference to the succeeding word vectors is unable to be performed. For example, in comparative technique 3, the text to be generated refers to the image, but reference from the image to the text to be generated is not performed. Accordingly, in comparative technique 3, it may be said that the correspondence between the image and the text is trained without reference from the image to the text.

However, in comparative technique 3, the neural network is not designed for the purpose of calculating the degree of similarity between the image and the text. Thus, it is not assumed that an image similar to text that is a search query is searched from an image that is a search target.

Accordingly, in each of the following embodiments, machine learning for generating corresponding text from an image is executed without reference from the image to text, so that a feature is generated in advance from a search-target image without depending on the search query while associating the image and the text with each other. This achieves both suppression of the degradation in accuracy of calculation of the degree of similarity and the increase in the speed of processing at the time of search. Hereinafter, the embodiments will be described in detail.

### First Embodiment

A search system according to a first embodiment includes a machine learning apparatus 10 and a search apparatus 30.

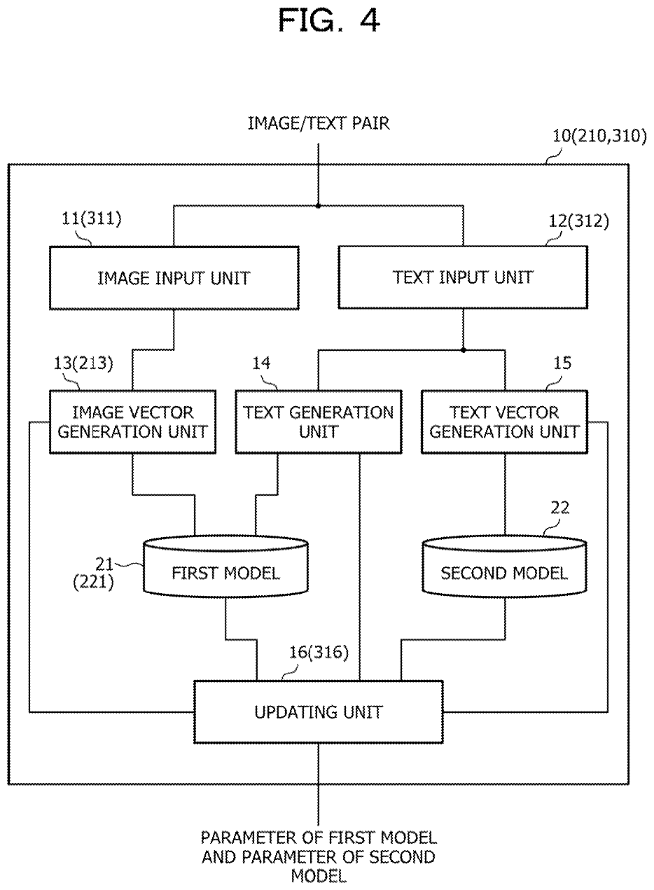

As illustrated in FIG. 4, the machine learning apparatus 10 functionally includes an image input unit 11, a text input unit 12, an image vector generation unit 13, a text generation unit 14, a text vector generation unit 15, and an updating unit 16. A first model 21 and a second model 22 are stored in a predetermined storage area of the machine learning apparatus 10.

A plurality of pairs of an image and corresponding text (hereinafter, referred to as an “image/text pair”) are input to the machine learning apparatus 10. Hereinafter, an image included in an image/text pair is referred to as a “training image”, and a text included in the image/text pair is referred to as a “correct answer corresponding text”. A correct answer corresponding text is an example of a “first training text” of the disclosed technique.

The image input unit 11 obtains a training image included in the image/text pair input to the machine learning apparatus 10, extracts elements of the training image, and transfers the elements to the image vector generation unit 13. The image input unit 11 recognizes an object included as a subject in a training image by using, for example, an object recognition technique and extracts an object vector indicating the recognized object as an element of the image. The object vector may include, for example, coordinate values representing the position of the object in the image, identification information indicating a category of the object, and the like. In the case where a training image tagged with information of the object included in the image in advance is used, the image input unit 11 may extract the information tagged to the image as the element of the training image. The image input unit 11 may extract a vector representing the entire image as the element of the image. The vector representing the entire image may include, for example, a statistical value such as an average, a variance, or the like of pixel values of the image. The element of the image is not limited to these examples and may be a pixel value of each pixel of the image, a divided image obtained by dividing the image on a predetermined-region-by-predetermined-region basis, or the like.

The text input unit 12 obtains the correct answer corresponding text included in the image/text pair input to the machine learning apparatus 10, extracts the elements of the correct answer corresponding text, and transfers the elements to the text generation unit 14. The text input unit 12 extracts, for example, the word vectors indicating the respective words included in the text as the elements of the text. The word vector may be, for example, a one-hot vector having the elements the number of which is a predetermined number of words. The text input unit 12 may extract a vector representing the entire text as the element of the text. The vector representing the entire text may include, for example, a statistical value such as the number of words, the incidence of each word, or the like. The element of the text is not limited to these examples and may be a numerical value obtained by replacing the word with identification information (word ID) or the like.

For a subset of the plurality of image/text pairs, the text input unit 12 randomly replaces the correct answer corresponding text included in the image/text pair with text not corresponding to the images included in the image/text pair. For example, the text input unit 12 replaces all or subset of pieces of the correct answer corresponding text included in a predetermined proportion (for example, 50%) of the plurality of image/text pairs with text prepared in advance independently of the training image, so that replacement with text not corresponding to the training image is performed. The text input unit 12 gives to the text included in the image/text pair having undergone the replacement process a correct answer as to whether the text is correctly paired with the image and sets the text as text with a correct answer. The text with a correct answer is an example of a “second training text” of the disclosed technique. For example, the text input unit 12 gives a correct answer indicating a correct pair to text that is not replaced, for example, correct answer corresponding text and gives a correct answer indicating that the pair is not correct to replaced text.

Hereinafter, text to which a correct answer indicating that the pair is not correct is given is referred to as “replacement text”. The text input unit 12 extracts, also from the replacement text, the elements of the text such as the word vectors in a manner similar to the above-described manner. The text input unit 12 transfers the elements of the text extracted from the text with a correct answer to the text vector generation unit 15 together with the correct answer.

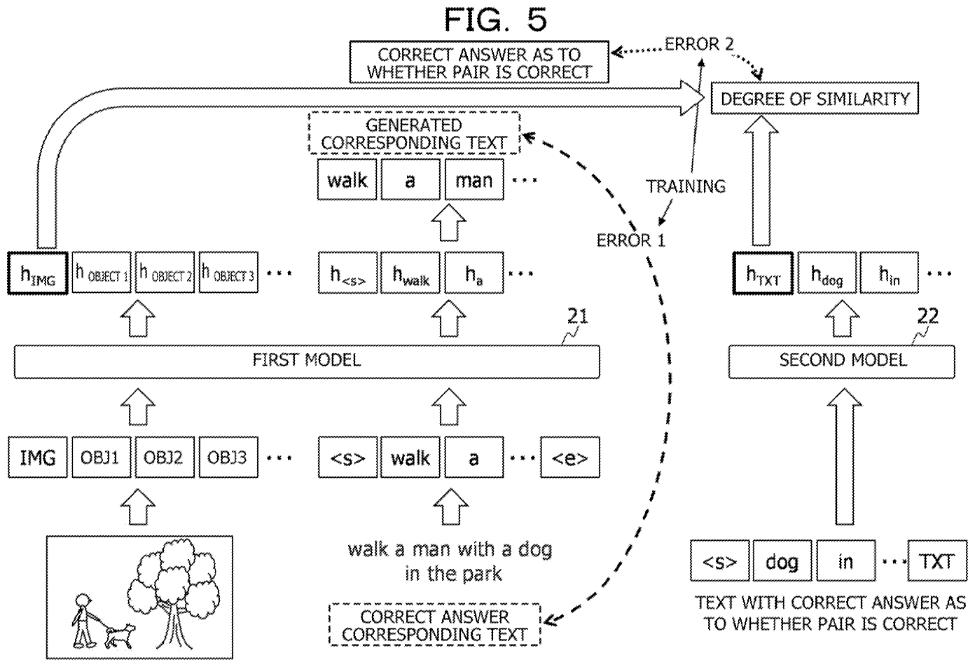

The image vector generation unit 13 inputs the elements of the image transferred from the image input unit 11 to the first model 21 that generates the image vector of the input image and that generates corresponding text for the image, and the image vector generation unit 13 obtains the image vector generated by the first model 21. The image vector is an example of a “feature of an image” in the disclosed technique. The first model 21 includes, for example, a neural network and, as illustrated in FIG. 5, generates an image vector h_{IMG} by integrating the features extracted from the individual elements of the input image. Here, referring to FIG. 5, a block of “IMG” represents the vector representing the entire image, and blocks such as “h_{OBJ1}”, “h_{OBJ2}”, “h_{OBJ3}”, . . . represent the features extracted from the individual object vectors. These representations are similarly used in the drawings to be referred to below. Although the details will be described later, the first model 21 generates the image vector h_{IMG} while mutually referring to the elements of the image and not referring to the elements of the text. The image vector generation unit 13 transfers the image vector h_{IMG} generated by the first model 21 to the updating unit 16.

The text generation unit 14 inputs to the first model 21 the correct answer corresponding text corresponding to the training image and obtains the corresponding text corresponding to the training image generated by the first model 21. As illustrated in FIG. 5, similarly to comparative technique 3 described above, the first model 21 predicts the next word by sequentially inputting the word vectors from the top word vector of the correct answer corresponding text and generates the corresponding text. In so doing, the text generation unit 14 refers to the elements of the image and the preceding elements of the text. In FIG. 5, blocks such as “h_{<s>}”, “h_{walk}”, “hₐ”, . . . represent the features extracted from the respective word vectors. These representations are similarly used in the drawings to be referred to below. The text generation unit 14 transfers to the updating unit 16 the correct answer corresponding text and the corresponding text generated by the first model 21.

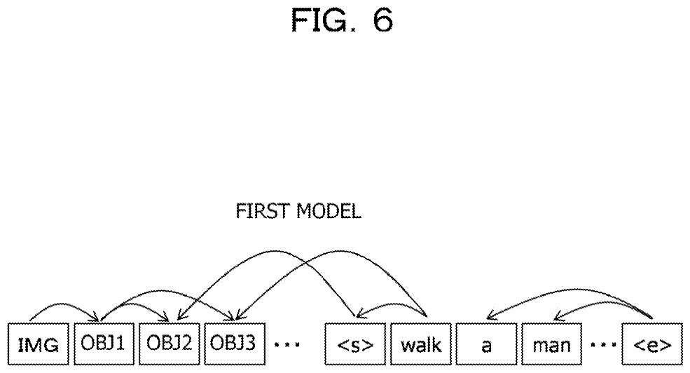

Here, with reference to FIG. 6, reference to each element when the image vector is generated and when the corresponding text is generated by the first model 21 is described in more detail. As illustrated in FIG. 6, when the image vector is generated, reference between the elements of the image is performed, but reference to the elements of the text is not performed. In contrast, when the corresponding text is generated, reference to the elements of the image is performed as well as reference to the elements of preceding text. For example, the first model 21 is a model that generates the image vector without referring to the corresponding text and generates the corresponding text by referring to the image. Such reference relationships are realized by setting of a network configuration of the neural network.

The text vector generation unit 15 inputs the text with a correct answer to the second model 22 that generates the text vector of the input text and obtains the text vector of the text with a correct answer generated by the second model 22. The text vector is an example of a “feature of text” in the disclosed technique. The second model 22 includes, for example, a neural network and, as illustrated in FIG. 5, generates a text vector h_{TXT} by integrating the features extracted from the individual elements of the input text. In so doing, the feature of each element is extracted by referring to all the other elements. Here, referring to FIG. 5, a block of “TXT” represents the vector representing the entire text, and blocks such as “h_{dog}”, “hᵢₙ”, . . . represent the features extracted from the individual word vectors. These representations are similarly used in the drawings to be referred to below. The text vector generation unit 15 transfers the text vector h_{TXT} generated by the second model 22 to the updating unit 16.

The updating unit 16 updates a parameter of the first model 21 and a parameter of the second model 22 so that an error between the correct answer corresponding text and the generated corresponding text and an error between the degree of similarity between the image vector h_{IMG} and the text vector h_{TXT} and the correct answer as to whether the pairing is correct converge.

For example, as illustrated in FIG. 5, the updating unit 16 calculates error 1 between the correct answer corresponding text input to the first model 21 and the corresponding text generated by the first model 21. For example, the updating unit 16 calculates error 1 between both the pieces of corresponding text by using, for example, the difference between the word vectors, the difference between vectors obtained by integrating the word vectors, or the difference between the incidences of the words of both the pieces of corresponding text. The updating unit 16 also calculates the degree of similarity between the image vector h_{IMG} generated by the first model 21 and the text vector h_{TXT} generated by the second model 22. For example, the updating unit 16 uses a linear function or the inner product of both the vectors to calculate the degree of similarity so that, in a value between 1 and 0, the degree of similarity becomes closer to 1 as the similarity between both the vectors increases and the degree of similarity becomes closer 0 as the similarity between both the vectors decreases. Here, it is assumed that a correct answer indicating a correct pair is set to 1 and a correct answer indicating not a correct pair is set to 0. The updating unit 16 calculates, as error 2, the difference between the calculated degree of similarity and the correct answer given to the text with a correct answer input to the second model 22.

The updating unit 16 updates the parameter of the first model 21 and the parameter of the second model 22 so that error 1 and error 2 having been calculated are decreased. The updating unit 16 repeats the calculation of error 1 and error 2 and the update of the parameters until an end condition of the machine learning is satisfied. The end condition of the machine learning is a condition under which it may be determined that error 1 and error 2 have converged. For example, the end condition of the machine learning may be a case where the number of times of repetition of the update of the parameters reaches a predetermined number of times, a case where error 1 and error 2 become smaller than or equal to predetermined values, or a case where the difference in error 1 between the previous time and this time and the difference in error 2 between the previous time and this time become smaller than or equal to predetermined values. The updating unit 16 outputs the parameter of the first model 21 and the parameter of the second model 22 when the end condition is satisfied.

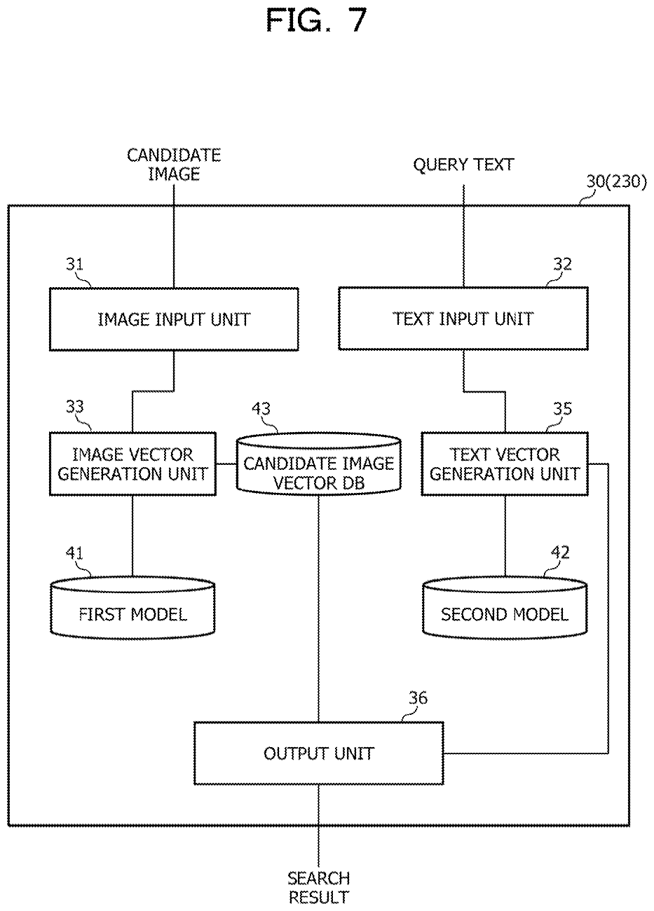

As illustrated in FIG. 7, the search apparatus 30 functionally includes an image input unit 31, a text input unit 32, an image vector generation unit 33, a text vector generation unit 35, and an output unit 36. A first model 41, a second model 42, and a candidate image vector database (DB) 43 are stored in a predetermined storage area of the search apparatus 30.

A plurality of candidate images to be serve as search targets are input to the search apparatus 30 at a preliminary preparation stage for the search. The candidate images may be the same images as the training images described above or may be different images from the training images. Query text to be serve as the search query is input to the search apparatus 30 at a search stage.

The first model 41 has a similar network configuration to that of the first model 21 used in the machine learning apparatus 10 and is a model in which a parameter output from the machine learning apparatus 10 is set, for example, a machine-learned model. Likewise, the second model 42 has a similar network configuration to that of the second model 22 used in the machine learning apparatus 10 and is a machine-learned model in which a parameter output from the machine learning apparatus 10 is set.

The image input unit 31 obtains the candidate images input to the search apparatus 30, extracts, for example, the object vectors and the vectors of the entire images as the elements of the candidate images, and transfers the object vectors and the vectors of the entire images to the image vector generation unit 33. A method of extracting the elements of the images is similar to that of the image input unit 11 of the machine learning apparatus 10.

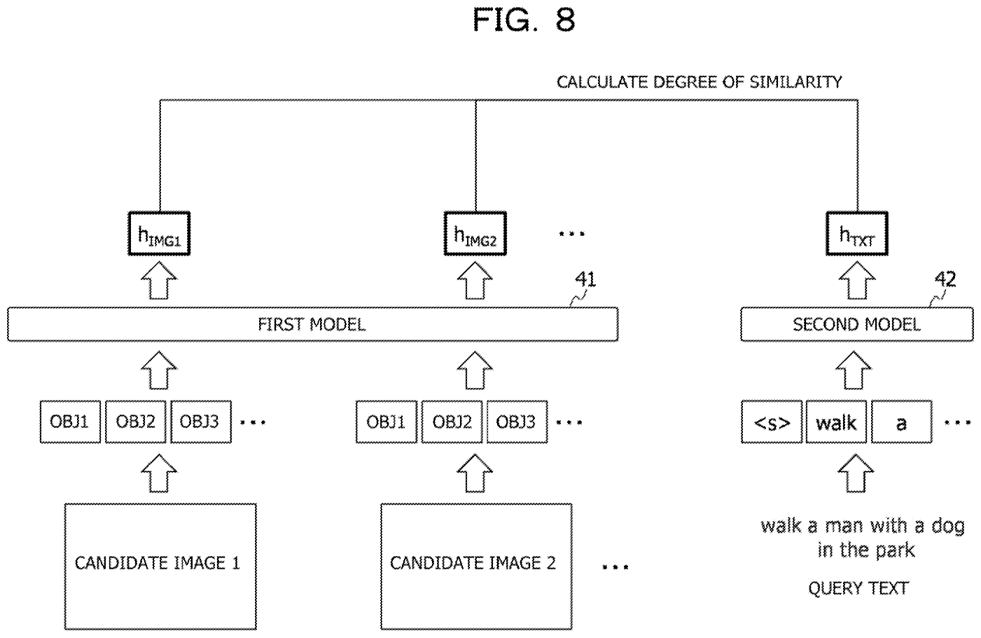

The image vector generation unit 33 inputs the elements of the candidate images transferred from the image input unit 31 to the machine-learned first model 41 and obtains the image vectors generated by the first model 41. For example, as illustrated in FIG. 8, the image vector generation unit 33 obtains image vectors h_{IMGi}; generated by the first model 41 from respective candidate images i (i=1, 2, . . . ). Here, the first model 41 may generate the image vectors without referring to the text, and machine learning is executed so that the machine learning may generate the text corresponding to the images. Thus, the first model 41 may generate the image vectors capturing correspondence with the text without depending on the text.

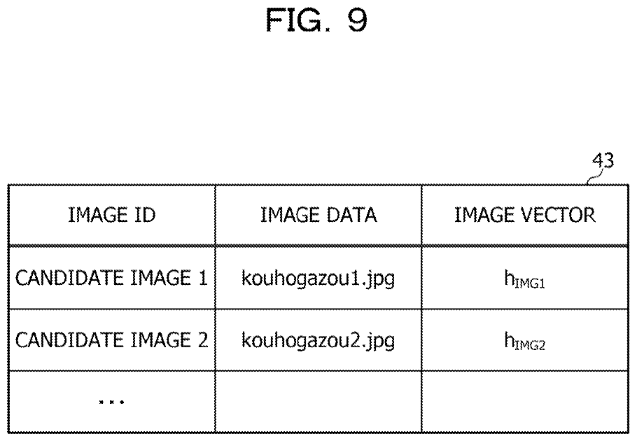

The image vector generation unit 33 stores in the candidate image vector DB 43 the generated image vectors h_{IMGi}; of the candidate images with the image vectors h_{IMGi}; associated with the candidate images i. FIG. 9 illustrates an example of the candidate image vector DB 43. In the example illustrated in FIG. 9, the candidate image vector DB 43 stores an “IMAGE ID” that is identification information of the candidate image, “IMAGE DATA” of the candidate image, and an “IMAGE VECTOR” generated for the candidate image with these items associated with each other.

The text input unit 32 obtains the query text input to the search apparatus 30, extracts, for example, the word vectors and the vector of the entire text as the elements of the query text, and transfers the word vectors and the vector of the entire text to the text vector generation unit 35. A method of extracting the elements of the text is similar to that of the text input unit 12 of the machine learning apparatus 10.

As illustrated in FIG. 8, the text vector generation unit 35 inputs the elements of the query text transferred from the text input unit 32 to the machine-learned second model 42 and obtains a text vector h_{TXT} of the query text generated by the second model 42. The text vector generation unit 35 transfers the text vector h_{TXT} of the query text to the output unit 36.

As illustrated in FIG. 8, the output unit 36 calculates, on an image-vector-by-image-vector basis, the degrees of similarity between the image vectors h_{IMGi}; of the candidate images stored in the candidate image vector DB 43 and the text vector h_{TXT} of the query text transferred from the text vector generation unit 35. A method of calculating the degree of similarity is similar to that of the updating unit 16 of the machine learning apparatus 10. The output unit 36 sequences the candidate images in a descending sequence of the calculated degrees of similarity and outputs the candidate images having undergone the sequencing as a search result of the images similar to the query text.

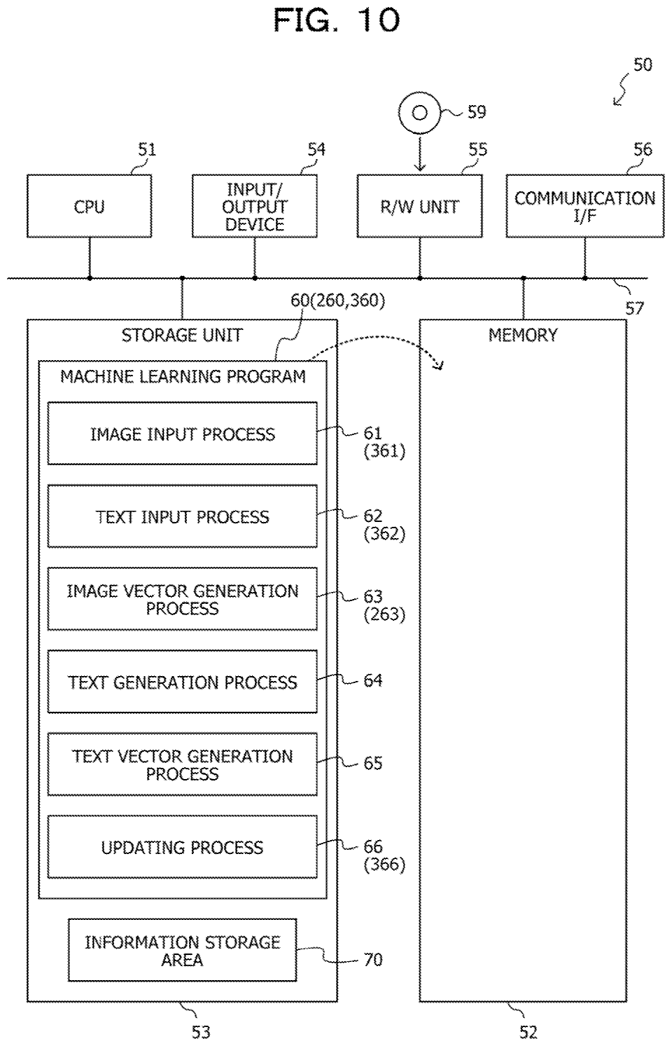

The machine learning apparatus 10 may be realized by using, for example, a computer 50 illustrated in FIG. 10. The computer 50 includes a central processing unit (CPU) 51, a memory 52 serving as a temporary storage area, and a storage unit 53 that is nonvolatile. The computer 50 also includes an input/output device 54 such as an input unit, a display unit, and the like and a read/write (R/W) unit 55 that controls reading and writing of data from and to a storage medium 59. The computer 50 also includes a communication interface (I/F) 56 that is coupled to a network such as the Internet. The CPU 51, the memory 52, the storage unit 53, the input/output device 54, the R/W unit 55, and the communication I/F 56 are coupled to each other via a bus 57.

The storage unit 53 may be realized by using a hard disk drive (HDD), a solid-state drive (SSD), a flash memory, or the like. The storage unit 53 serving as a storage medium stores a machine learning program 60 for causing the computer 50 to function as the machine learning apparatus 10. The machine learning program 60 includes an image input process 61, a text input process 62, an image vector generation process 63, a text generation process 64, a text vector generation process 65, and an updating process 66. The storage unit 53 includes an information storage area 70 in which information included in the first model 21 and the second model 22 is stored.

The CPU 51 reads the machine learning program 60 from the storage unit 53, loads the read machine learning program 60 on the memory 52, and sequentially executes the processes included in the machine learning program 60. The CPU 51 executes the image input process 61 to operate as the image input unit 11 illustrated in FIG. 4. The CPU 51 executes the text input process 62 to operate as the text input unit 12 illustrated in FIG. 4. The CPU 51 executes the image vector generation process 63 to operate as the image vector generation unit 13 illustrated in FIG. 4. The CPU 51 executes the text generation process 64 to operate as the text generation unit 14 illustrated in FIG. 4. The CPU 51 executes the text vector generation process 65 to operate as the text vector generation unit 15 illustrated in FIG. 4. The CPU 51 executes the updating process 66 to operate as the updating unit 16 illustrated in FIG. 4. The CPU 51 reads information from the information storage area 70 and loads each of the first model 21 and the second model 22 on the memory 52. In this way, the computer 50 that executes the machine learning program 60 functions as the machine learning apparatus 10. The CPU 51 that executes the program is hardware.

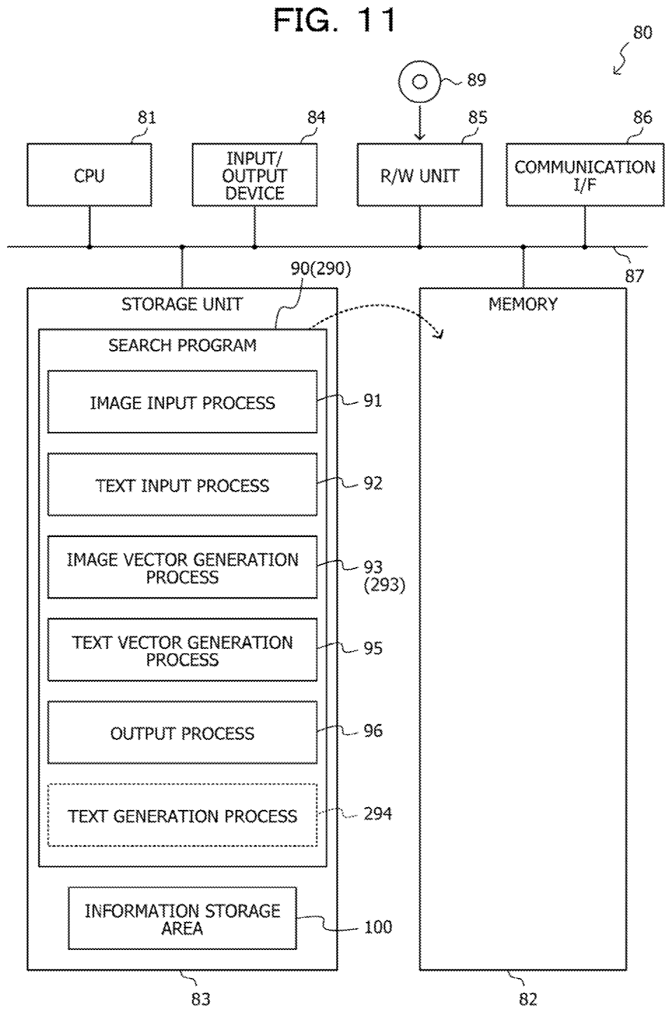

The search apparatus 30 may be realized by using, for example, a computer 80 illustrated in FIG. 11. The computer 80 includes a CPU 81, a memory 82 serving as a temporary storage area, and a storage unit 83 that is nonvolatile. The computer 80 also includes an input/output device 84, an R/W unit 85, and a communication I/F 86. The R/W unit 85 controls reading and writing of data from and to a storage medium 89. The CPU 81, the memory 82, the storage unit 83, the input/output device 84, the R/W unit 85, and the communication I/F 86 are coupled to each other via a bus 87.

The storage unit 83 may be realized by an HDD, an SSD, a flash memory, or the like. The storage unit 83 serving as a storage medium stores a search program 90 for causing the computer 80 to function as the search apparatus 30. The search program 90 includes an image input process 91, a text input process 92, an image vector generation process 93, a text vector generation process 95, and an output process 96. The storage unit 83 includes an information storage area 100 in which information included in the first model 41, the second model 42, and the candidate image vector DB 43 is stored.

The CPU 81 reads the search program 90 from the storage unit 83, loads the search program 90 on the memory 82, and sequentially executes the processes included in the search program 90. The CPU 81 executes the image input process 91 to operate as the image input unit 31 illustrated in FIG. 7. The CPU 81 executes the text input process 92 to operate as the text input unit 32 illustrated in FIG. 7. The CPU 81 executes the image vector generation process 93 to operate as the image vector generation unit 33 illustrated in FIG. 7. The CPU 81 executes the text vector generation process 95 to operate as the text vector generation unit 35 illustrated in FIG. 7. The CPU 81 executes the output process 96 to operate as the output unit 36 illustrated in FIG. 7. The CPU 81 reads information from the information storage area 100 and loads each of the first model 41, the second model 42, and the candidate image vector DB 43 on the memory 82. In this way, the computer 80 that executes the search program 90 functions as the search apparatus 30. The CPU 81 that executes the program is hardware.

The functions realized by each of the machine learning program 60 and the search program 90 may also be realized by using, for example, a semiconductor integrated circuit, in more detail, an application-specific integrated circuit (ASIC) or the like.

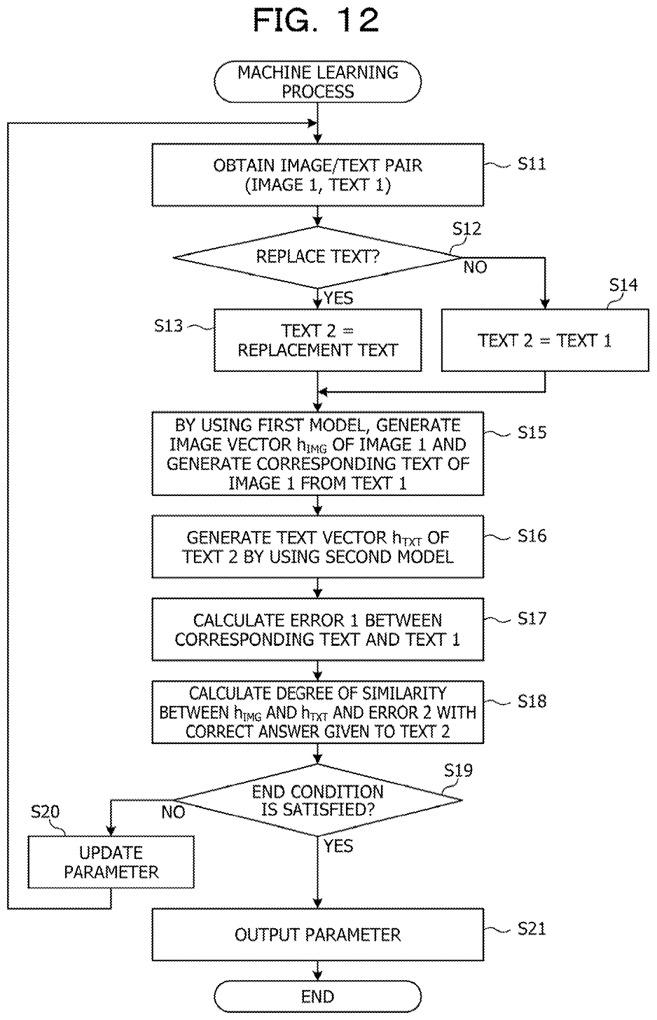

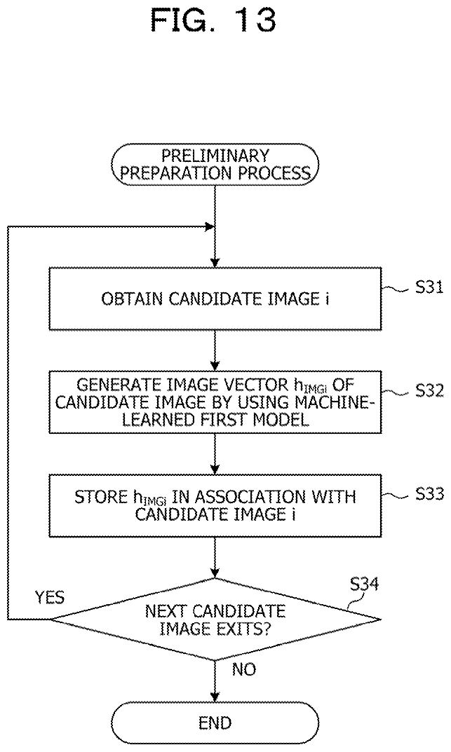

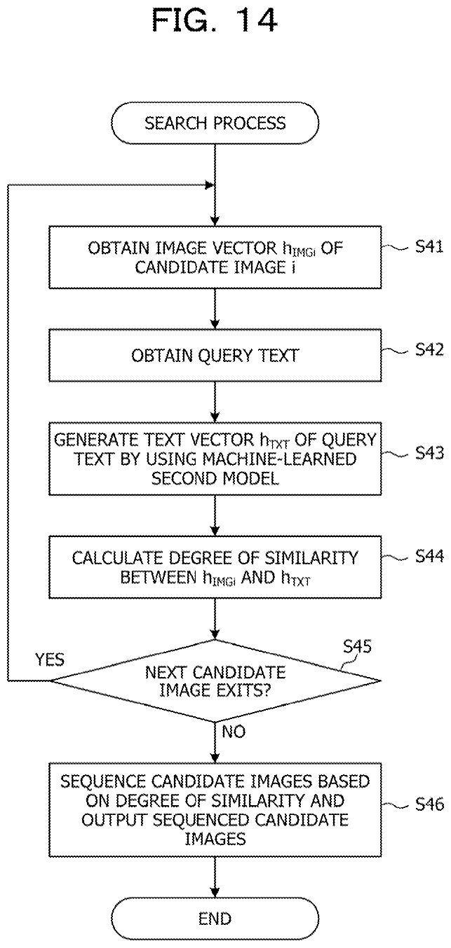

Next, operation of the search system according to the first embodiment will be described. At a machine learning stage, when the image/text pair is input to the machine learning apparatus 10 and execution of machine learning is instructed, the machine learning apparatus 10 executes a machine learning process illustrated in FIG. 12. At a preliminary preparation stage of a search process, when the candidate image is input to the search apparatus 30 and the preliminary preparation is instructed, the search apparatus 30 executes a preliminary preparation process illustrated in FIG. 13. At the search stage, when the query text is input to the search apparatus 30 and an instruction to search for the similar image is given, the search apparatus 30 executes the search process illustrated in FIG. 14. Hereinafter, each of the machine learning process, the preliminary preparation process, and the search process will be described in detail. The machine learning process is an example of a method of machine learning of the disclosed technique.

First, the machine learning process illustrated in FIG. 12 will be described.

In step S11, the image input unit 11 and the text input unit 12 obtain the image/text pair input to the machine learning apparatus 10. The image and the text included in the image/text pair obtained here are respectively referred to as “image 1, and “text 1”.

Next, in step S12, the text input unit 12 determines whether to replace text 1 of the image/text pair with the replacement text. For example, the text input unit 12 is set to replace a predetermined proportion (for example, 50%) of number of pieces of text 1 of image/text pair input to the machine learning apparatus 10 and randomly determines whether to replace text 1. In a case where text 1 is replaced, the process proceeds to step S13. In a case where text 1 is not replaced, the process proceeds to step S14.

In step S13, the text input unit 12 sets the replacement text to which the correct answer indicating that the pair is not correct is given as “text 2”. In contrast, in step S14, the text input unit 12 gives the correct answer indicating that the pair is correct to text 1 and sets this text 1 as text 2.

Next, in step S15, the image input unit 11 extracts the elements of the image from image 1 and transfers the elements of the image to the image vector generation unit 13. The image vector generation unit 13 inputs the transferred elements of the image to the first model 21 and obtains the image vector h_{IMG} generated by the first model 21 without reference to the elements of text 1. At the same time, the text input unit 12 extracts the elements of the text from text 1 and transfers the elements to the text generation unit 14. The text generation unit 14 inputs the transferred elements of the text to the first model 21 and obtains the corresponding text generated by the first model 21 with reference to the elements of image 1. The image vector generation unit 13 transfers the image vector h_{IMG} to the updating unit 16, and the text generation unit 14 transfers text 1 and the generated corresponding text to the updating unit 16.

Next, in step S16, the text input unit 12 extracts the elements of the text from text 2 and transfers the extracted elements of the text to the text vector generation unit 15. The text vector generation unit 15 inputs the transferred elements of the text to the second model 22 and obtains the text vector h_{TXT} generated by the second model 22. The text vector generation unit 15 transfers the text vector h_{TXT} to the updating unit 16.

Next, in step S17, the updating unit 16 calculates error 1 between the corresponding text generated in step S15 described above and text 1. Next, in step S18, the updating unit 16 calculates the degree of similarity between the image vector h_{IMG} generated in step S15 described above and the text vector h_{TXT} generated in step S16 described above (in the value from 0 to 1, the degree of similarity increases as it becomes closer to 1). Here, it is assumed that a correct answer indicating a correct pair is set to 1 and a correct answer indicating not a correct pair is set to 0. The updating unit 16 calculates, as error 2, the difference between the calculated degree of similarity and the correct answer given to text 2.

Next, in step S19, the updating unit 16 determines whether the end condition of the machine learning indicating that error 1 and error 2 have converged is satisfied. In a case where the end condition is not satisfied, the process proceeds to step S20, in which the updating unit 16 updates the parameter of the first model 21 and the parameter of the second model 22 so that error 1 and error 2 decrease, and the process returns to step S11. In contrast, in a case where the end condition is satisfied, the process proceeds to step S21, the parameter of the first model 21 and the parameter of the second model 22 when the end condition is satisfied are output, and the machine learning process ends.

Next, the preliminary preparation process illustrated in FIG. 13 will be described.

In step S31, the image input unit 31 obtains the candidate image i (i=1, 2, . . . ) input to the search apparatus 30. Next, in step S32, the image input unit 31 extracts the elements of the image from the candidate image i and transfers the elements of the image to the image vector generation unit 33. The image vector generation unit 33 inputs the elements of the candidate image i to the machine-learned first model 41 that may generate the image vector capturing correspondence with the text without depending on the text and obtains the image vector h_{IMGi}; of the candidate image i generated by the first model 41.

Next, in step S33, the image vector generation unit 33 stores in the candidate image vector DB 43 the generated image vector h_{IMGi}; with the image vector h_{IMGi}; associated with the candidate image i. Next, in step S34, the image input unit 31 determines whether a next candidate image exists. In a case where the next candidate image exists, the process returns to step S31. In a case where the next candidate image does not exist, the preliminary preparation process ends.

Next, the search process illustrated in FIG. 14 will be described.

In step S41, the output unit 36 selects one of the candidate images i from the candidate image vector DB 43 and obtains the image vector h_{IMGi} stored in association with this candidate image i. In step S42, the text input unit 32 obtains the query text input to the search apparatus 30.

Next, in step S43, the text input unit 32 extracts the elements of the text from the query text and transfers the elements to the text vector generation unit 35. The text vector generation unit 35 inputs the elements of the query text to the machine-learned second model 42 and obtains the text vector h_{TXT} of the query text generated by the second model 42. The text vector generation unit 35 transfers the text vector h_{TXT} to the output unit 36.

Next, in step S44, the output unit 36 calculates the degree of similarity between the image vector h_{IMGi}; obtained in step S41 and the text vector h_{TXT} generated in step S43 described above. The output unit 36 associates the calculated degree of similarity with the candidate image i and stores the degree of similarity in a predetermined storage area once. Next, in step S45, the output unit 36 determines whether a next candidate image exists in the candidate image vector DB 43. In a case where the next candidate image exists, the process returns to step S41. In a case where the next candidate image does not exist, the process proceeds to step S46.

In step S46, the output unit 36 refers to the degree of similarity for each candidate image i stored in the predetermined storage area, sequences the candidate images i in a descending sequence of the degrees of similarity, outputs the candidate images having undergone the sequencing as the search result of the images similar to the query text, and the search process ends.

As described above, with a machine learning system according to the first embodiment, the machine learning apparatus generates the image vector of the training image by inputting the training image to the first model that generates the image vector representing the feature of the input image and that generates the text corresponding to the image. The machine learning apparatus inputs the correct answer corresponding text of the training image to the first model and generates the corresponding text of the training image. The machine learning apparatus inputs, to the second model that generates the text vector representing the feature of the input text, the text with a correct answer for which the correct answer as to whether to correspond to the training image is known and generates the text vector of the text with a correct answer. The machine learning apparatus updates the parameter of the first model and the parameter of the second model so that the error between the correct answer corresponding text and the generated corresponding text and the error between the degree of similarity between the image vector and the text vector and the correct answer converge. In this way, in a case where the image similar to the text that is the search query is searched from images that are the search targets, both suppression of the degradation in accuracy of calculation of the degree of similarity and the increase in speed of the processing at the time of search may be achieved.

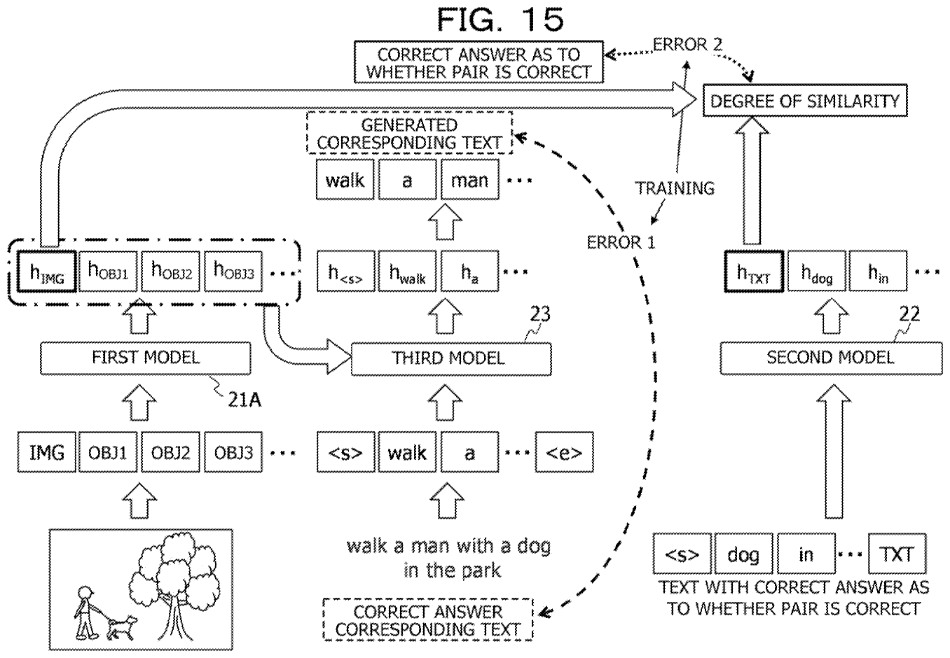

Although the case where the generation of the image vector and the generation of the corresponding text are simultaneously performed in the first model is described according to the first embodiment, this is not limiting. For example, as illustrated in FIG. 15, after the image vector h_{IMG} has been generated by a first model 21A, the corresponding text of the image may be generated by a third model 23 based on the generated image vector h_{IMG} and the correct answer corresponding text. Also in this case, a parameter of the first model 21A is updated so that, when machine learning is performed, the image vector h_{IMG} which decreases error 1 between the corresponding text generated by the third model 23 and the correct answer corresponding text is generated. Thus, the first model 21A is a model that may generate the image vectors capturing correspondence with the text without depending on the text. FIG. 15 illustrates an example in which, in the third model 23, the features (“h_{OBJ1}”, “h_{OBJ2}”, “h_{OBJ3}”, . . . ) of the individual object vectors extracted by the first model 21A are also used together with the image vector h_{IMG} to generate the corresponding text.

### Second Embodiment

Next, a second embodiment will be described. The case where the text is not referred to when the image vector is generated in the first model 21 has been described according to the first embodiment. However, a case where reference to at least part of the text input to the first model is allowed will be described according to the second embodiment. The configurations of the search system according to the second embodiment that are similar to those of the search system according to the first embodiment are denoted by the same reference signs, thereby omitting detailed description thereof. For the functional configurations denoted by reference signs the last two digits of which are common between the first embodiment and the second embodiment, description of the details of the common functions is omitted.

The search system according to the second embodiment includes a machine learning apparatus 210 and a search apparatus 230.

As illustrated in FIG. 4, the machine learning apparatus 210 functionally includes the image input unit 11, the text input unit 12, an image vector generation unit 213, the text generation unit 14, the text vector generation unit 15, and the updating unit 16. A first model 221 and the second model 22 are stored in a predetermined storage area of the machine learning apparatus 210.

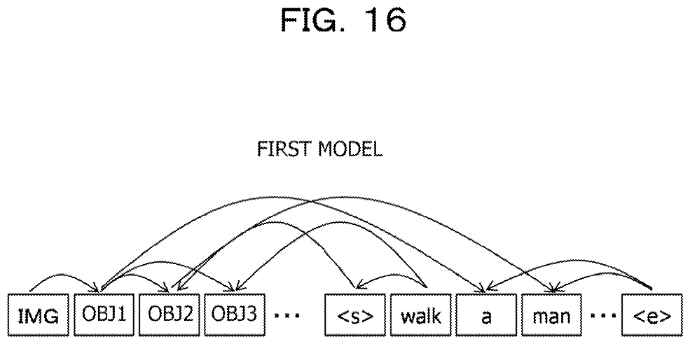

The image vector generation unit 213 inputs the elements of the image transferred from the image input unit 11 to the first model 221 and obtains the image vector generated by the first model 221. In so doing, as illustrated in FIG. 16, the first model 221 generates the image vector by also referring to the elements of the text input to the first model 221 by the text generation unit 14.

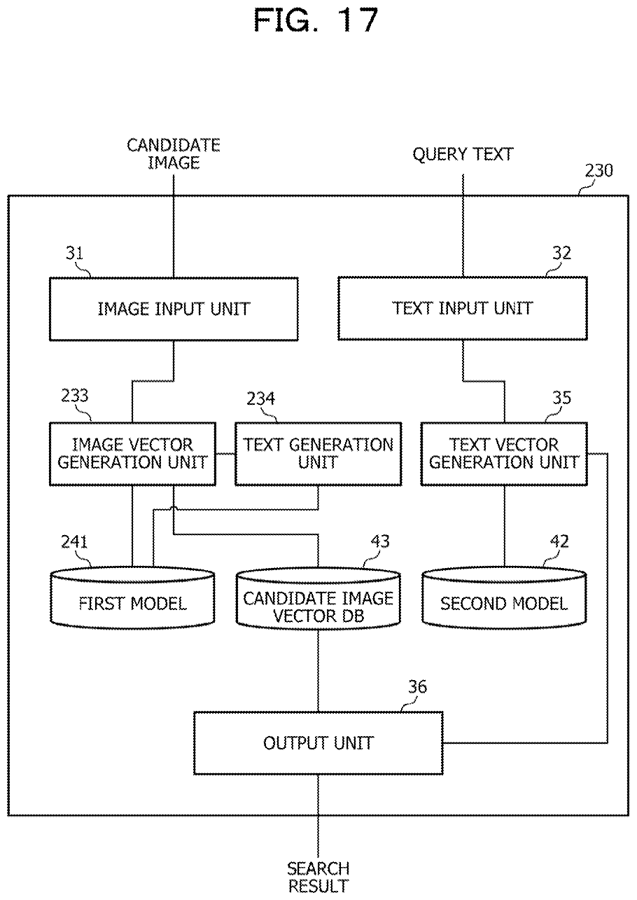

As illustrated in FIG. 17, the search apparatus 230 functionally includes the image input unit 31, the text input unit 32, an image vector generation unit 233, a text generation unit 234, the text vector generation unit 35, and the output unit 36. A first model 241, the second model 42, and the candidate image vector DB 43 are stored in a predetermined storage area of the search apparatus 230.

The text generation unit 234 inputs the vector indicating the start of the text (<s>) to the machine-learned first model 241 and obtains a word predicted by the first model 241 based on the elements of the candidate image and <s>. The text generation unit 234 adds the obtained word to the elements of the candidate image and <s>, inputs the result of the addition to the first model 241, and obtains the corresponding text of the candidate image to be generated by further repeating prediction of the next word by using the first model 241. The text generation unit 234 transfers the obtained corresponding text to the image vector generation unit 233.

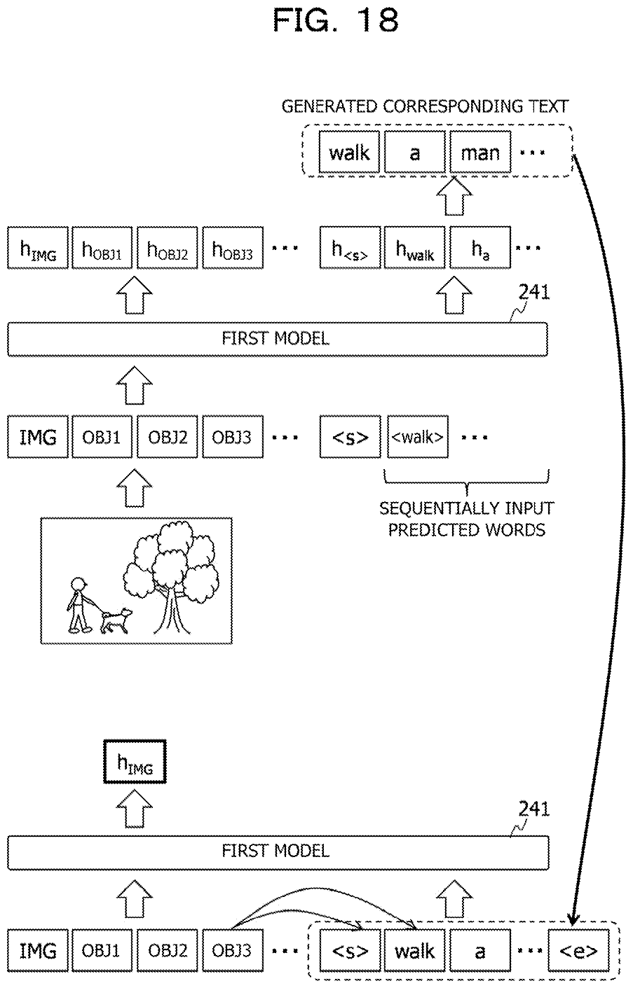

The image vector generation unit 233 inputs the elements of the candidate image to the first model 241 and receives from the text generation unit 234 the corresponding text generated based on the input elements of the candidate image. Upon receiving the corresponding text, the image vector generation unit 233 inputs the elements of the candidate image to the first model 241 again and also inputs the elements of the received corresponding text. In this way, as illustrated in FIG. 18, the first model 241 may generate the image vector h_{IMG} by also referring to the elements of the corresponding text. The image vector generation unit 233 stores in the candidate image vector DB 43 the image vector h_{IMG} generated by also referring to the elements of the corresponding text in association with the candidate image.

The machine learning apparatus 210 may be realized by using, for example, the computer 50 illustrated in FIG. 10. The storage unit 53 of the computer 50 stores a machine learning program 260 for causing the computer 50 to function as the machine learning apparatus 210. The machine learning program 260 includes the image input process 61, the text input process 62, an image vector generation process 263, the text generation process 64, the text vector generation process 65, and the updating process 66. The storage unit 53 includes the information storage area 70 in which information included in the first model 221 and the second model 22 is stored.

The CPU 51 reads the machine learning program 260 from the storage unit 53, loads the read machine learning program 260 on the memory 52, and sequentially executes the processes included in the machine learning program 260. The CPU 51 executes the image vector generation process 263 to operate as the image vector generation unit 213 illustrated in FIG. 4. The CPU 51 reads information from the information storage area 70 and loads each of the first model 221 and the second model 22 on the memory 52. The other processes are similar to those in the machine learning program 60 according to the first embodiment. In this way, the computer 50 that executes the machine learning program 260 functions as the machine learning apparatus 210.

The search apparatus 230 may be realized by using, for example, the computer 80 illustrated in FIG. 11. The storage unit 83 of the computer 80 stores a search program 290 for causing the computer 80 to function as the search apparatus 230. The search program 290 includes the image input process 91, the text input process 92, an image vector generation process 293, a text generation process 294, the text vector generation process 95, and the output process 96. The storage unit 83 includes the information storage area 100 in which information included in the first model 241, the second model 42, and the candidate image vector DB 43 is stored.

The CPU 81 reads the search program 290 from the storage unit 83, loads the search program 290 on the memory 82, and sequentially executes the processes included in the search program 290. The CPU 81 executes the image vector generation process 293 to operate as the image vector generation unit 233 illustrated in FIG. 17. The CPU 81 executes the text generation process 294 to operate as the text generation unit 234 illustrated in FIG. 17. The CPU 81 reads information from the information storage area 100 and loads each of the first model 241, the second model 42, and the candidate image vector DB 43 on the memory 82. The other processes are similar to those in the search program 90 according to the first embodiment. In this way, the computer 80 that executes the search program 290 functions as the search apparatus 230.

The functions realized by the machine learning program 260 and the search program 290 may also be realized by, for example, a semiconductor integrated circuit, in more detail, an ASIC or the like.

Next, operation of the search system according to the second embodiment will be described. At the machine learning stage, as is the case with the first embodiment, the machine learning apparatus 210 executes the machine learning process illustrated in FIG. 12. According to the second embodiment, when the first model 221 generates the image vector h_{IMG} in step S15 of the machine learning process illustrated in FIG. 12, the elements of text 1 input to the first model 221 are also referred to.

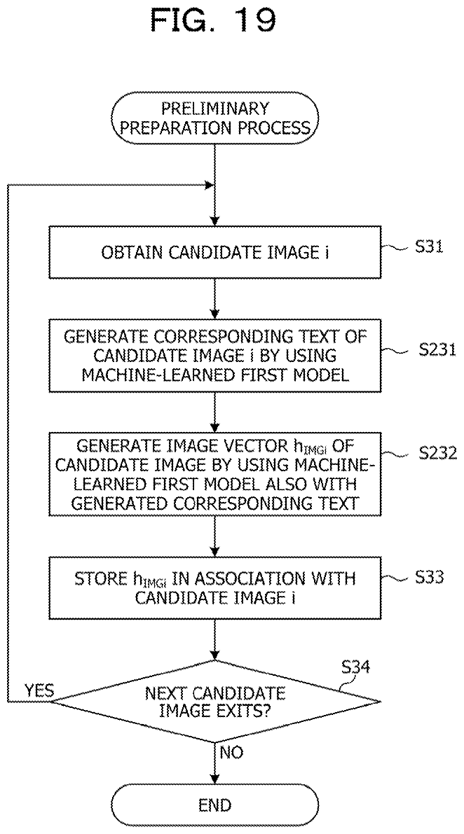

At a preliminary preparation stage of the search process, when the candidate image is input to the search apparatus 230 and the preliminary preparation is instructed, the search apparatus 230 executes the preliminary preparation process illustrated in FIG. 19. At the search stage, when the query text is input to the search apparatus 230 and an instruction to search for the similar image is given, the search apparatus 230 executes the search process illustrated in FIG. 14. The search process is similar to that in the first embodiment. Hereinafter, the preliminary preparation process will be described in detail. Processes in the preliminary preparation process according to the second embodiment that are similar to those in the preliminary preparation process according to the first embodiment (FIG. 13) are denoted by the same step numbers, thereby omitting detailed description thereof.

After processing through step S31, in the next step S231, the image vector generation unit 233 inputs the elements of the candidate image i to the first model 241, and the text generation unit 234 inputs the vector (<s>) indicating the start of the text to the first model 241. The text generation unit 234 inputs to the first model 241 the next words sequentially predicted by the first model 241 to obtain the corresponding text, generated by the first model 241, of the candidate image i. The text generation unit 234 transfers the obtained corresponding text to the image vector generation unit 233.

Next, in step S232, the image vector generation unit 233 inputs the elements of the candidate image i to the first model 241 again and also inputs the elements of the received corresponding text. The image vector generation unit 233 obtains the image vector h_{IMGi} that the first model 241 generates by referring to the elements of the corresponding text in addition to the elements of the candidate image i, and the process proceeds to step S33.

As has been described, with the search system according to the second embodiment, the machine learning apparatus generates the image vector by also allowing reference to the corresponding text by the first model. The search apparatus inputs the corresponding text generated by the first model to the first model again and causes the corresponding text to be referred to when the image vector is generated. In this way, compared to the first embodiment, ease of the training of the association between the image and the text may increase, and degradation in accuracy of calculation of the degree of similarity may be further suppressed.

### Third Embodiment

Next, a third embodiment will be described. According to the third embodiment, a case is described where machine learning is executed in a self-complementary manner so as to suppress degradation in accuracy of calculation of the degree of similarity even in a case where a small change in the image or text occurs between time of machine learning and time of preliminary preparation and search. The configurations of the search system according to the third embodiment that are similar to those of the search system according to the first embodiment are denoted by the same reference signs, thereby omitting detailed description thereof. For the functional configurations denoted by reference signs the last two digits of which are common between the first embodiment and the third embodiment, description of the details of the common functions is omitted.

The search system according to the third embodiment includes a machine learning apparatus 310 and the search apparatus 30.

As illustrated in FIG. 4, the machine learning apparatus 310 functionally includes an image input unit 311, a text input unit 312, the image vector generation unit 13, the text generation unit 14, the text vector generation unit 15, and an updating unit 316. The first model 21 and the second model 22 are stored in a predetermined storage area of the machine learning apparatus 310.

As is the case with the image input unit 11 according to the first embodiment, the image input unit 311 extracts the elements of the image from the training image. The image input unit 311 randomly masks a subset of the extracted elements of the image. For example, it is assumed that an object vector (4, 3, 2, 5, 2, 8) is extracted as one of the elements of the training image, and this object vector is to be masked. In this case, the image input unit 311 masks the object vector (4, 3, 2, 5, 2, 8) by converting the object vector (4, 3, 2, 5, 2, 8) into (0, 0, 0, 0, 0, 0). An image input unit 311 transfers the elements of the training image the subset of which has been masked to the image vector generation unit 13.

As is the case with the text input unit 12 according to the first embodiment, the text input unit 312 extracts the elements of the text from the text with a correct answer. The text input unit 312 randomly masks a subset of the extracted elements of the text. For example, the text input unit 312 masks a word ID extracted as one of the elements of the text with a correct answer by converting this word ID to be masked into a word ID representing a mask or a word ID representing another word. For example, it is assumed that “word ID=12 (for example, a word ID representing the word” in “)” is included in the extracted elements of the text, and this element of the text is to be masked. In this case, the text input unit 312 masks “word ID=12” by converting “word ID=12” into, for example, “word ID=700 (word ID representing a mask)” or “word ID=34 (for example, word ID representing the word” blue “)”. The text input unit 312 transfers the elements of the text with a correct answer the subset of which has been masked to the text vector generation unit 15.

As is the case with the updating unit 16 according to the first embodiment, the updating unit 316 updates the parameter of the first model 21 and the parameter of the second model 22 so that error 1 and error 2 converge. Error 1 is an error between the correct answer corresponding text and the generated corresponding text, and error 2 is an error between the correct answer and the degree of similarity between the image vector h_{IMG} and the text vector h_{TXT}. In so doing, the updating unit 316 updates the parameter of the first model 21 so that the original element before the masking is predictable based on the feature extracted by the first model 21 from the masked training image. Likewise, the updating unit 316 updates the parameter of the second model 22 so that the original element before the masking is predictable based on the feature extracted by the second model 22 from the masked text with a correct answer. For example, the updating unit 316 executes machine learning of each of the first model 21 and the second model 22 so that the feature corresponding to the original element before the masking is extracted as the feature corresponding to the masked element.

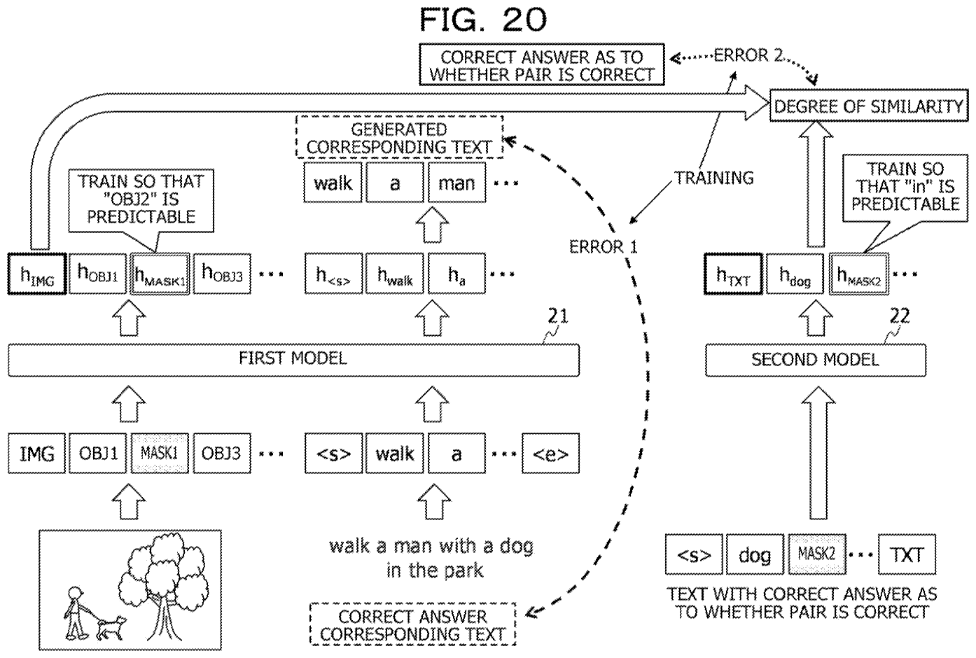

For example, in a case similar to that of FIG. 5 described according to the first embodiment, it is assumed that, as illustrated in FIG. 20, the image input unit 311 masks the object vector “OBJ2” to obtain “MASK1”. In this case, the updating unit 316 updates the parameter of the first model 21 so that the original object vector “OBJ2” is predictable from the feature vector “h_{MASK1}” of “MASK1” extracted by the first model 21. Also, it is assumed that the text input unit 312 masks the word vector “in” to obtain “MASK2”. In this case, the updating unit 316 updates the parameter of the second model 22 so that the original word vector “in” is predictable from the feature vector “h_{MASK2}” of “MASK2” extracted by the second model 22.

The machine learning apparatus 310 may be realized by using, for example, the computer 50 illustrated in FIG. 10. The storage unit 53 of the computer 50 stores a machine learning program 360 for causing the computer 50 to function as the machine learning apparatus 310. The machine learning program 360 includes an image input process 361, a text input process 362, the image vector generation process 63, the text generation process 64, the text vector generation process 65, and an updating process 366. The storage unit 53 includes the information storage area 70 in which information included in the first model 21 and the second model 22 is stored.

The CPU 51 reads the machine learning program 360 from the storage unit 53, loads the read machine learning program 360 on the memory 52, and sequentially executes the processes included in the machine learning program 360. The CPU 51 executes the image input process 361 to operate as the image input unit 311 illustrated in FIG. 4. The CPU 51 executes the text input process 362 to operate as the text input unit 312 illustrated in FIG. 4. The CPU 51 executes the updating process 366 to operate as the updating unit 316 illustrated in FIG. 4. The other processes are similar to those in the machine learning program 60 according to the first embodiment. In this way, the computer 50 that executes the machine learning program 360 functions as the machine learning apparatus 310.

The functions realized by the machine learning program 360 may also be realized by, for example, a semiconductor integrated circuit, in more detail, an ASIC or the like.

Since the search apparatus 30 is similar to that of the first embodiment, description thereof is omitted.

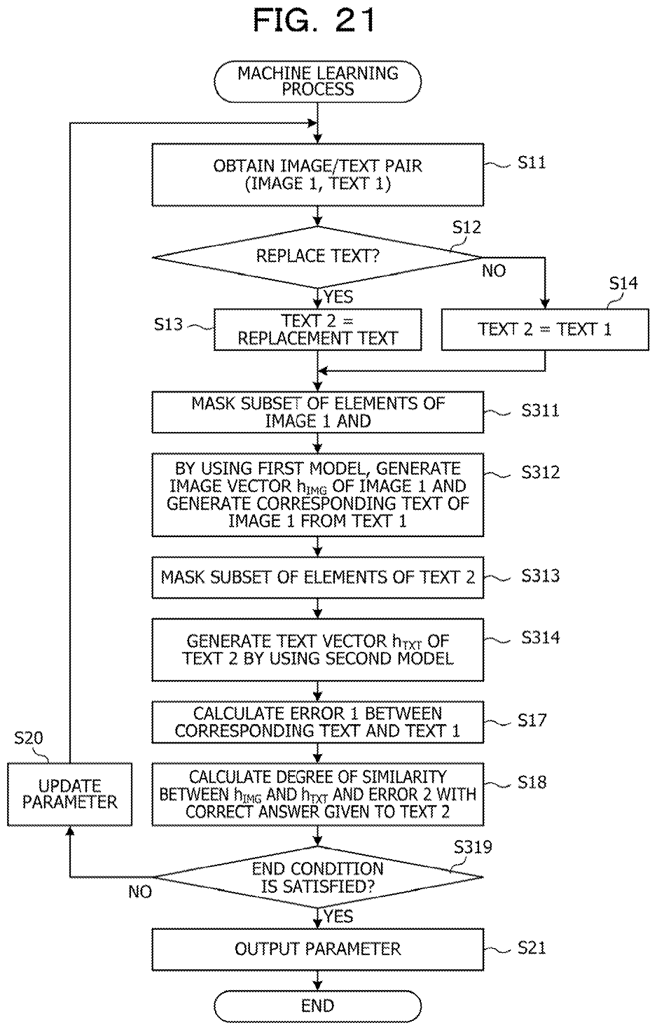

Next, operation of the search system according to the third embodiment will be described. At the machine learning stage, the machine learning apparatus 310 executes the machine learning process illustrated in FIG. 21. In the preliminary preparation stage, the search apparatus 30 executes the preliminary preparation process illustrated in FIG. 13 as is the case with the first embodiment, and in the search stage, the search apparatus 30 executes the search process illustrated in FIG. 14 as is the case with the first embodiment. Hereinafter, the machine learning process will be described in detail. Processes in the machine learning process according to the third embodiment that are similar to those in the machine learning process according to the first embodiment (FIG. 12) are denoted by the same step numbers, thereby omitting detailed description thereof.

After processing through steps S11 to S14, in the next step S311, the image input unit 311 extracts the elements of the image from image 1 and randomly masks a subset of the extracted elements of image 1. The image input unit 311 transfers the elements of image 1 the subset of which has been masked to the image vector generation unit 13.

Next, in step S312, the image vector generation unit 13 inputs the transferred elements of the image to the first model 21 and obtains the image vector h_{IMG} generated by the first model 21. Also, the text input unit 12 extracts the elements of the text from text 1 and transfers the elements to the text generation unit 14. The text generation unit 14 inputs the transferred elements of the text to the first model 21 and obtains the corresponding text generated by the first model 21. The image vector generation unit 13 transfers the image vector h_{IMG} to the updating unit 316, and the text generation unit 14 transfers text 1 and the generated corresponding text to the updating unit 316.

Next, in step S313, the text input unit 312 extracts the elements of the text from text 2 and randomly masks a subset of the extracted elements of text 2. Then, the text input unit 312 transfers the elements of text 2 the subset of which has been masked to the text vector generation unit 15.

Next, in step S314, the text vector generation unit 15 inputs the transferred elements of text 2 to the second model 22 and obtains the text vector h_{TXT} generated by the second model 22. The text vector generation unit 15 transfers the text vector h_{TXT} to the updating unit 316.

Next, after processing through steps S17 and S18, in the next step S319, the updating unit 316 determines whether end conditions of the machine learning are satisfied. Here, the end conditions include, in addition to the condition that error 1 and error 2 converge, a condition that, for the masked elements, the original elements are predictable from the features extracted by each of the first model 21 and the second model 22.

As described above, with the search system according to the third embodiment, the machine learning apparatus masks a subset of the elements of the image input to the first model and a subset of the elements of the text input to the second model. For the masked element, the machine learning apparatus updates the parameters of the first model and the second model so that the original elements are predictable from the features extracted by the first model and the second model. When the machine learning is executed in a self-complementary manner as described above, degradation in accuracy of calculation of the degree of similarity may be suppressed even in the case where a small change in the image or text occurs between time of machine learning and time of preliminary preparation and search.

Although the case where the machine learning apparatus and the search apparatus are realized by separate computers has been described in each of the above-described embodiments, the machine learning apparatus and the search apparatus may be realized by the same computer.

Although the case is described where the candidate images sequenced in a descending sequence of the degrees of similarity are output as the search result according to each of the above-described embodiments, this is not limiting. The candidate images the degree of similarity of which is greater than or equal to a predetermined value may be output without being sequenced, or only the candidate image with the greatest degree of similarity may be output.

According to each of the above-described embodiments, a form in which the machine learning program and the search program are installed in advance in the storage unit is described. However, this is not limiting. The program according to the disclosed technique may be provided in a form in which the programs are stored in a storage medium such as a compact disc read-only memory (CD-ROM), a Digital Versatile Disc (DVD)-ROM, or a Universal Serial Bus (USB) memory.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing a machine learning program that causes at least one computer to execute a process, the process comprising:
obtaining a first model to which an image is input and a text corresponding to the image is input word by word, the first model generating a feature of the image and predicting words of the text that have not been input to the first model;
generating a feature of a training image by inputting the training image to the first model;
predicting words of a text corresponding to the training image by inputting first training text corresponding to the training image to the first model word by word;
generating a feature of second training text, for which a correct answer as to whether the second training text corresponds to the training image is known, by inputting the second training text to a second model that generates a feature of text input to the second model; and
changing a parameter of the first model and a parameter of the second model so that a first error and a second error decrease, the first error being between the first training text and the generated text corresponding to the training image, the second error being between the correct answer and a degree of similarity between the feature of the training image and the feature of the second training text.

2. The non-transitory computer-readable storage medium according to claim 1, wherein the generating the feature of the training image includes generating the feature of the training image without referring to the first training text input to the first model.

3. The non-transitory computer-readable storage medium according to claim 1, wherein the generating the feature of the training image includes generating the feature of the training image by referring to at least part of the first training text input to the first model.

4. The non-transitory computer-readable storage medium according to claim 1, wherein
the generating the feature of the training image and the generating the text corresponding to the training image are simultaneously performed.

5. The non-transitory computer-readable storage medium according to claim 1, wherein
the predicting includes predicting the words of the text corresponding to the training image by using the generated feature of the training image.

6. The non-transitory computer-readable storage medium according to claim 1, wherein the process further comprising
executing machine learning of the first model and the second model by masking a subset of elements included in the training image and a subset of elements included in the second training text.

7. The non-transitory computer-readable storage medium according to claim 1, wherein the process further comprising:
based on the first model for which machine learning has been executed, generating and storing respective features of a plurality of candidate images that are to serve as search targets;
based on the second model for which the machine learning has been executed, generating a feature of query text that is to serve as a search query; and
based on a degree of similarity between the feature of each of the candidate images and the feature of the query text, sequencing the plurality of candidate images and outputting the plurality of candidate images that have been sequenced.

8. A machine learning apparatus comprising:
one or more memories; and
one or more processors coupled to the one or more memories and the one or more processors configured to:
obtain a first model to which an image is input and a text corresponding to the image is input word by word, the first model generating a feature of the image and predicting words of the text that have not been input to the first model,
generate a feature of a training image by inputting the training image to the first model,
predict words of a text corresponding to the training image by inputting first training text corresponding to the training image to the first model word by word,
generate a feature of second training text, for which a correct answer as to whether the second training text corresponds to the training image is known, by inputting the second training text to a second model that generates a feature of text input to the second model, and
change a parameter of the first model and a parameter of the second model so that a first error and a second error decrease, the first error being between the first training text and the generated text corresponding to the training image, the second error being between the correct answer and a degree of similarity between the feature of the training image and the feature of the second training text.

9. A machine learning method for a computer to execute a process comprising:
obtaining a first model to which an image is input and a text corresponding to the image is input word by word, the first model generating a feature of the image and predicting words of the text that have not been input to the first model;
generating a feature of a training image by inputting the training image to the first model;
predicting words of a text corresponding to the training image by inputting first training text corresponding to the training image to the first model word by word;
generating a feature of second training text, for which a correct answer as to whether the second training text corresponds to the training image is known, by inputting the second training text to a second model that generates a feature of text input to the second model; and
changing a parameter of the first model and a parameter of the second model so that a first error and a second error decrease, the first error being between the first training text and the generated text corresponding to the training image, the second error being between the correct answer and a degree of similarity between the feature of the training image and the feature of the second training text.
